(19) United States
(12) Patent Application Publication
(10) Pub. No.: US 2026/0146855 A1
(43) Pub. Date: May 28, 2026

(54) VEHICLE AND METHOD OF CONTROLLING THE SAME

(71) Applicants: HYUNDAI MOTOR COMPANY, Seoul (KR); KIA CORPORATION, Seoul (KR); HYUNDAI AUTOEVER CORP., Seoul (KR)

(72) Inventors: Nam Hyuk KIM, Gyeonggi-do (KR); Ga Eun NA, Gyeonggi-do (KR); Byeong Jun MOON, Seoul (KR); Soo Keun YUN, Seoul (KR)

(73) Assignees: HYUNDAI MOTOR COMPANY, Seoul (KR); KIA CORPORATION, Seoul (KR); HYUNDAI AUTOEVER CORP., Seoul (KR)

(21) Appl. No.: 19/216,611

(22) Filed: May 22, 2025

(30) Foreign Application Priority Data
Oct. 11, 2024 (KR) 10-2024-0138538

(51) Int. Cl. G01C 21/34; G01C 21/36

(52) U.S. Cl. CPC G01C 21/3446; G01C 21/3655

(57) ABSTRACT

A vehicle includes one or more processors and a memory storing programs executed by the processors. The processors determine a driving probability to a destination for each branch point, including a departure point, using stored past driving route data. A weight is computed for each branch point based on its distance from the departure point and changes in driving probability from a previous point. A final driving probability is calculated by applying the weight to the driving probability. Based on this probability, the vehicle recommends a destination and generates an optimal route. This system enhances route prediction and driving efficiency by analyzing historical navigation patterns.

### CROSS-REFERENCE TO RELATED APPLICATION

This application claims priority to and the benefit of Korean Patent Application No. 10-2024-0138538, filed on Oct. 11, 2024, the disclosure of which is incorporated herein by reference in its entirety.

### BACKGROUND

### 1. Field of the Invention

Embodiments relate to a vehicle and a method for controlling the same.

### 2. Discussion of Related Art

Navigation systems installed in vehicles and the like have brought convenience to users in medium- to long-distance travel, and as navigation technology is applied to mobile devices such as smartphones, it has become possible to identify a current location and check a route to a destination not only on the roads where vehicles travel, but also in alleys, squares, and indoors. Furthermore, with the incorporation of navigation technology into autonomous vehicles, drivers can now select the most efficient route to reach their destination.

The navigation system recommends the most efficient route to reach a destination, and the route is automatically searched for and displayed on a map based on a current location of a user. In this case, most of the routes recommended by the navigation system are usually searched for based on distance and time.

However, in the case of routes on which a driver regularly drives, such as routes to work, home, school, and the like, there is an inconvenience of having to set a route at each driving time point.

### SUMMARY OF THE INVENTION

The present invention relates to a vehicle capable of automatically suggesting a suitable destination and driving route based on the vehicle's driving record, as well as a method for controlling the vehicle. According to an aspect of the present invention, there is provided a vehicle including one or more processors and a memory storing one or more programs executed by the one or more processors, in which the processor includes a first processing unit configured to determine each driving probability to a destination for each of branch points including a departure point using past driving route data stored in the memory, a second processing unit configured to determine a weight for each branch point based on a distance from the departure point and an amount of change in the driving probability from a previous point, a third processing unit configured to determine a final driving probability by reflecting the weight in the driving probability, and a fourth processing unit configured to recommend a destination based on the final driving probability.

The first processing unit may accumulate the number of arrivals at a destination from a branch point based on past driving route data of the vehicle and determine the driving probability based on the ratio of a cumulative sum value. based on The first processing unit may classify the past driving route data of the vehicle based on day-of-the-week information and time information and determine the driving probability.

The second processing unit may determine a first weight that decreases based on the distance from the departure point.

The second processing unit may determine a probability difference value from a previous driving probability in a driving route order, and determine a second weight that increases based on the probability difference value.

The second processing unit may determine a third weight using the first weight and the second weight.

The third processing unit may determine the final driving probability by reflecting the third weight in the driving probability for each branch point.

When an estimated destination whose final driving probability is equal to or greater than a preset threshold probability is derived, the fourth processing unit may recommend a route based on the estimated destination at a corresponding branch point.

The fourth processing unit may display a driving route based on the estimated destination through a navigation unit.

The fourth processing unit may recommend a route based on the estimated destination at a time point of passing through the corresponding branch point.

According to another aspect of the present invention, there is provided a method performed by a computing apparatus including one or more processors and a memory storing one or more programs executed by the one or more processors, including determining, by the processor, a driving probability to a destination for each of branch points including a departure point using past driving route data stored in the memory, determining, by the processor, a weight for each branch point based on a distance from the departure point and an amount of change in the driving probability from a previous point, determining, by the processor, a final driving probability by reflecting the weight in the driving probability, and recommending, by the processor, a destination based on the final driving probability.

The determining of the driving probability may include accumulating the number of times of arrival at the destination from the branch point based on the past driving route data of the vehicle and determining the driving probability based on a ratio of a cumulative sum value.

The determining of the driving probability may include classifying the past driving route data of the vehicle based on day-of-the-week information and time information and determining the driving probability.

The determining of the weight may include determining a first weight that decreases based on the distance from the departure point.

The determining of the weight may further include determining a probability difference value from a previous driving probability in a driving route order and determining a second weight that increases based on the probability difference value.

The determining of the weight may further include determining a third weight using the first weight and the second weight.

The determining of the final driving probability may include determining the final driving probability by reflecting the third weight in the driving probability for each branch point.

The recommending of the destination may include recommending a route based on an estimated destination at a corresponding branch point when the estimated destination whose final driving probability is equal to or greater than a preset threshold probability is derived.

The recommending of the destination may further include displaying a driving route based on the estimated destination through a navigation unit.

The recommending of the destination may further include recommending a route based on the estimated destination at a time point of passing through the corresponding branch point.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a vehicle transmitting and receiving data through communication with another device;

FIG. 2 is a diagram showing modules constituting a vehicle based on one embodiment of the present disclosure;

FIG. 3 is a conceptual diagram of the operation of a processor based on the embodiment;

FIGS. 4 to 7 are diagrams illustrating the operation of a first processing unit;

FIG. 8 is a diagram for describing the operation of a processor based on an embodiment; and

FIG. 9 is a flowchart of a method for controlling a vehicle based on an embodiment.

### DETAILED DESCRIPTION OF EXEMPLARY EMBODIMENTS

Hereinafter, preferred embodiments of the present invention will be described in detail with reference to the accompanying drawings.

However, the technical idea of the present invention is not limited to some embodiments to be described but may be implemented in various different forms, and within the scope of the technical idea of the present invention, one or more among components in the embodiments may be selectively combined or substituted.

Furthermore, unless specifically defined and described, terms used in the embodiments of the present invention (including technical and scientific terms) may be interpreted as meanings which are generally understood by those skilled in the art to which the present invention pertains, and commonly used terms such as terms defined in dictionaries may be interpreted in consideration of the contextual meaning of the related art.

The terms used in the embodiments of the present invention are solely for describing the embodiments only and are not intended to limit the invention.

In the present specification, the singular forms may include the plural forms unless the context clearly dictates otherwise, and when described as “at least one (or one or more) among A, B, and (or) C,” it may include one or more of all possible combinations of A, B, and C.

In addition, when describing components of embodiments of the present invention, terms such as first, second, A, B, (a), (b), etc., may be used.

These terms are only for distinguishing the components from other components, and the essence, sequence, or order of the components is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Furthermore, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component.

Hereinafter, embodiments will be described in detail with reference to the accompanying drawings, but the same or corresponding components are denoted by the same reference numerals regardless of the drawing numbers, and redundant descriptions will be omitted.

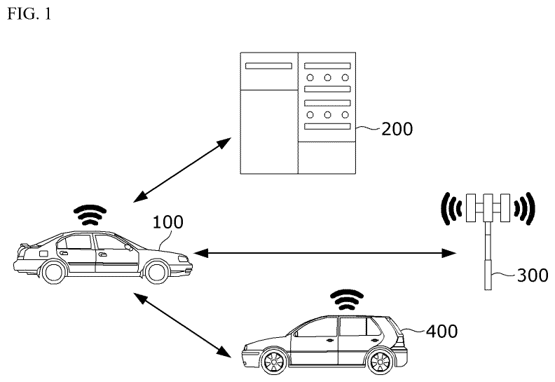

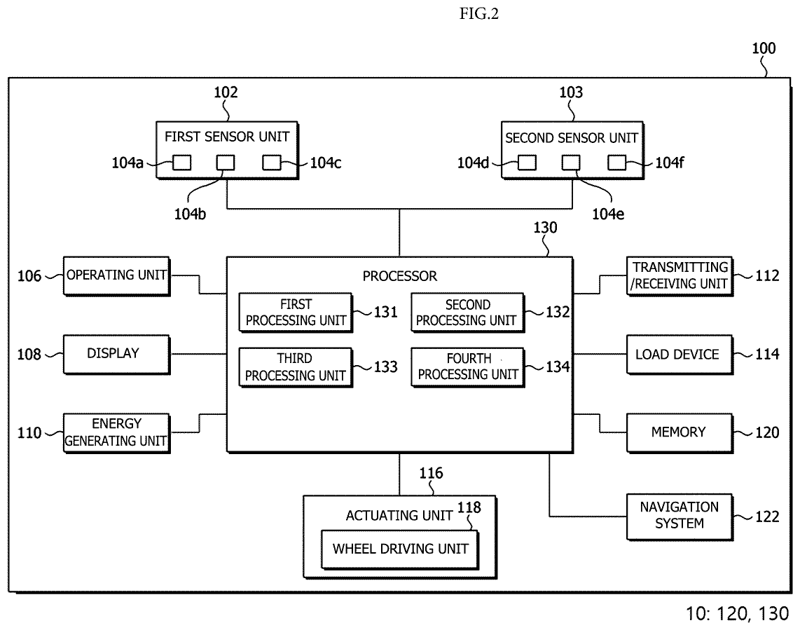

Hereinafter, a vehicle will be described with reference to FIGS. 1 and 2. FIG. 1 is a diagram illustrating a vehicle transmitting and receiving data by communicating with another device;

Referring to FIG. 1, a vehicle 100 may be powered by electrical energy or fossil fuels. In the case of electrical energy, the vehicle 100 may be, for example, a pure battery-based vehicle driven only by a high-voltage battery, or may employ a gas-based fuel cell as an energy source. In addition, the fuel cell may use various types of gas capable of generating electrical energy, and the vehicle 100 may be filled with gas in a liquefied state, for example. Here, the gas may be hydrogen as one example. However, the gas is not limited thereto, and various gases are applicable. In the case of fossil energy, the vehicle 100 is driven based on fuel such as gasoline, diesel or liquefied gas, and may be equipped with an internal combustion engine that drives an actuating unit 116 by combustion of the fuel. The engine may be included in an energy generating unit 110 in terms of providing a driving rotational force of wheels to a wheel driving unit 118. As another example, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. Here, the ground vehicle may be referred to as any vehicle including a vehicle that moves underground as well as a vehicle that moves over land. The vehicle 100 may be considered a robot in a broad sense, serving as a means of movement, and it may operate using wheels, tracks, or other mobility modules. In the present disclosure, ground mobility devices such as ground vehicles are mainly described, but unless it contradicts the present disclosure, the present embodiment may also be applied to air mobility devices such as AAMs, aircraft, or the like, and water mobility devices such as ships, submarines.

The vehicle 100 may be controlled and operated using autonomous driving, and the autonomous driving may be implemented as semi-autonomous driving or fully autonomous driving. Fully autonomous driving may be provided as autonomous movement in which a processor 130 of the vehicle 100 takes full control without user intervention, even when a driving situation is uncertain. Semi-autonomous driving may be provided as autonomous movement that requires driver intervention depending on specific driving situations. The semi-autonomous driving may be implemented so that the processor 130 transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1 to 4, and the fully autonomous driving may correspond to level 5.

Additionally, the vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving, and may receive connected data of the vehicle 100 or transmit data necessary for autonomous driving. The server 200 may transmit various information and software modules used to control the vehicle 100 to the vehicle 100 in response to requests and data transmitted from the vehicle 100 and the user device to support autonomous driving and various services of the vehicle 100.

The ITS device 300 may be, for example, a roadside unit (RSU), and the ITS device 300 may assist the user in driving his or her own vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data listed above through V2V communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a WiFi communication network, a WAVE communication network, or the like, for communication with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the above-described embodiment.

FIG. 2 is a diagram showing modules constituting a vehicle based on one embodiment of the present disclosure.

The vehicle 100 may include a sensor unit 102, an operating unit 106, a display 108, a load device 114, and a transmitting/receiving unit 112.

The sensor unit 102 may be provided with various types of detectors to detect various states and situations occurring in an external environment, an internal system, user operation, and a boarding space of the vehicle 100.

Specifically, a first sensor unit 102 may be provided with an externally oriented camera 104a, a lidar sensor 104b, a radar sensor 104c, and the like, to recognize dynamic and static objects present outside the vehicle 100. The camera 104a may recognize an external object as an image while the vehicle 100 is in use, generate image data, and transmit the image data to the processor 130. The lidar sensor 104b may generate point cloud data as recognized data of the external object and transmit the point cloud data to the processor 130 to generate 3D spatial information that identifies at least a shape of the external object. In order to ascertain the presence of an external object and its relative distance, speed, direction, or the like, the radar sensor 104c may emit radio waves of a specific frequency around the vehicle 100 and generate radar data through radio waves reflected from the external object. In the present disclosure, the sensor unit is illustrated as having the lidar sensor 104b, but in other examples, the lidar sensor 104b may not be mounted.

The first sensor unit 102 may generate object recognition data based on sensing data. The object recognition information may include information on the presence of an object, position information about the object, information on a distance between the vehicle 100 and the object, and information on a relative speed between the vehicle 100 and the object. In the embodiment, external objects may be various objects related to the operation of the vehicle 100.

A second sensor unit 103 may be provided with a positioning sensor 104d, a wheel sensor 104e, an attitude sensor 104f, and the like, to confirm its own location, speed, driving attitude, and the like. The attitude sensor 104f may include a gyro sensor, an angular velocity sensor, an acceleration sensor, or the like. The attitude sensor may be an inertial measurement unit (IMU) sensor and may be equipped with a 3-axis accelerometer and a 3-axis gyroscope. The attitude sensor may measure acceleration in a traveling direction (x), acceleration in a lateral direction (y), and acceleration in a height direction (z) of the vehicle 100, and a yaw, a pitch, and a roll as the angular velocity of the vehicle.

The second sensor unit 103 may generate vehicle traveling information based on sensing data. The vehicle traveling information may be information generated based on data detected by various sensors installed inside the vehicle. For example, vehicle travel data may include information on vehicle attitude, speed, inclination, weight, direction, battery status, fuel level, tire pressure, steering position, interior temperature, interior humidity, pedal position, and engine temperature, among other parameters.

Additionally, the vehicle traveling information may include route information. The route information may be generated based on a destination input by a vehicle user through the operating unit 106. The route information may indicate a traveling route from a current vehicle position to a destination on a map when the destination has been set. When no destination is set, the route information may refer to information including a road on which a host vehicle is currently traveling and a future driving route including the road.

The operating unit 106 may be configured as a module controlled by the user for driving. For example, the operating unit 106 may be a steering wheel for manual driving, an automatic or manual shift transmission, an accelerator pedal, a brake pedal, or the like. The operating unit 106 may be further provided with an interface for enabling or disabling an autonomous driving mode and selecting detailed functions requested by the user so that the user may use the autonomous driving function. In order to receive various requests related to autonomous driving, the operating unit 106 may be configured, for example, as a hard-type interface provided at a predetermined position inside the vehicle 100, or as a soft-type interface that can be touched on the display 108. Depending on the specifications of the autonomous vehicle, at least one of the steering wheel, the transmission, and the pedal may be omitted. As another example, the operating unit 106 may be provided with a module that receives a user's control request for the load device 114 in addition to driving control.

The display 108 may function as a user interface. The display 108 may output and display an operating state, a control state, route/traffic information, remaining energy amount information, content requested by the driver, or the like, of the vehicle 100 by the processor 130. In addition, the display 108 may be configured as a touch screen capable of detecting a driver's input to receive a driver's request to instruct the processor 130.

The load device 114, mounted on the vehicle 100, may be a non-driving electrical device, excluding driving power systems such as the wheel driving unit 118. The load device 114 is an auxiliary device that receives electrical power from the energy generating unit 110, and may be, for example, an air conditioning system, a lighting system, a seat system, various devices installed in the vehicle 100, or the like. In the present disclosure, a cooling/heating system that cools or heats at least one of a battery, a fuel cell, an internal combustion engine, an air conditioning system, and a specific part of the vehicle 100 may be further included.

The transmitting/receiving unit 112 may support mutual communication with the server 200, the ITS device 300, surrounding vehicles 300, and the like. The transmitting/receiving unit 112 may include a module that processes, for example, cellular communication, WAVE, DSRC communication, and the like. In the present disclosure, the transmitting/receiving unit 112 may transmit data generated or stored while driving to the server 200 and receive data and software modules transmitted from the server 200. The transmitting/receiving unit 112 may support communication with an electronic device carried by an occupant inside the vehicle 100. In the present disclosure, the vehicle 100 may transmit and receive data utilized in a method based on the present disclosure to and from the outside through the transmitting/receiving unit 112.

For example, the transmitting/receiving unit 112 may receive traffic signal information from a traffic signal controller and provide the traffic signal information to the processor 130. In addition, the transmitting/receiving unit 112 may receive a control signal from the traffic signal controller and provide the control signal to the processor 130.

In addition, the vehicle 100 may include the energy generating unit 110 and the actuating unit 116.

The energy generating unit 110 may generate and supply power and electric power used in a driving power system and a non-driving power system, such as the actuating unit 116. The non-driving power system may be, for example, the sensor unit 102, the operating unit 106, the display 108, the load device 114, and the transmitting/receiving unit 112, but is not limited thereto, and may include various components that implement sensing, interface, communication, and convenience functions, excluding components directly involved in driving operations. When the vehicle 100 is driven based on electrical energy, the energy generating unit 110 may be configured as an electric battery charged from the outside, or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen. When the vehicle 100 operates on fossil fuel, the energy generation unit 110 may be an internal combustion engine. In addition, when the vehicle 100 is a hybrid type, the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, based on a user request from the operating unit 106. To execute driving operations based on a command of the processor 130 by manual operation of the user or autonomous driving, the actuating unit 116 may be provided with the wheel driving unit 118 and mechanical components and electronic modules for implementing the driving operations in the wheel driving unit 118. When the vehicle 100 is operated based on electrical energy, the actuating unit 116 may include an assembly for transmitting the requested driving operation to the wheel driving unit 118. When the vehicle 100 is operated based on fossil energy, the actuating unit 116 may be provided with a transmission and a gear module that transmit the power of the internal combustion engine.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation unit 122 may provide navigation information. The navigation information may include at least one of map information, set destination information, route information based on a set destination, information on various objects on the route, lane information, and current vehicle position information.

The navigation unit 122 may receive information from an external device through the transmitting/receiving unit 112 and update previously stored information. Based on the embodiment, the navigation unit 122 may be classified as a sub-component of the operating unit 106.

Additionally, the vehicle 100 may include a memory 120 and a processor 130.

The memory 120 may store applications and various types of data for controlling the vehicle 100, and load applications or read and record data upon request by the processor 130.

The processor 130 may perform overall control of the vehicle 100. The processor 130 may be configured to execute applications and instructions stored in the memory 120.

In the embodiment, driving route data may include a vehicle ID, day-of-the-week information, time information, departure point information, destination information, a latitude, a longitude, lane information, and the like.

The driving route data of the vehicle may be divided into regular trajectories and irregular trajectories. In the embodiment, the processor 130 may suggest a destination based on a departure point using a regular trajectory on which a predetermined number of times or more of trips have been made on a specific day of the week and a time section.

The processor 130 may comprise a first processing unit 131, a second processing unit 132, a third processing unit 133, and a fourth processing unit 134.

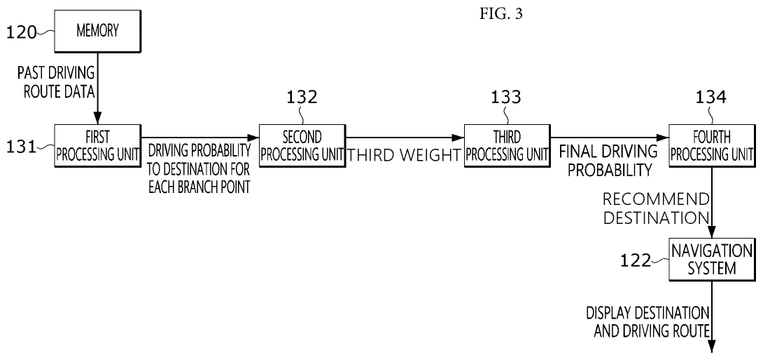

FIG. 3 is a conceptual diagram of the operation of the processor based on the embodiment. Referring to FIG. 3, the first processing unit 131 may determine a driving probability to a destination for each branch point including a departure point using past driving route data stored in the memory.

The first processing unit 131 may determine the driving probability using driving route data for a certain period of time in the past. In this case, the first processing unit 131 may extract only routes where the number of times of reaching a specific destination from a specific departure point is equal to or greater than a preset threshold number, and determine the driving probability for branch points located on the corresponding routes. This is because more meaningful route recommendations are possible only when a certain number of driving routes or more have been accumulated.

In the embodiment, the departure point may be a point where the vehicle movement starts and may include a home, a company, and the like.

In the embodiment, the branch point may refer to a point where a road extending in a single path branches into multiple paths, such as an intersection, a highway entrance, a highway exit, or the like, between the departure point and the destination, including the departure point.

In the following embodiments, the branch point may be used as a term that includes the departure point, and may be used with the same meaning as a link.

In the embodiment, the destination may be a point where the vehicle movement ends and may include a home, a company, and the like.

The first processing unit 131 may accumulate the number of times of arrival at the destination from the branch point based on past driving route data of the vehicle, and determine the driving probability based on a ratio of a cumulative sum value. In this case, the first processing unit 131 may classify the past driving route data of the vehicle based on the day-of-the-week information and time information and determine the driving probability.

The first processing unit 131 may accumulate and determine the number of times of arrival at the destination for each branch point. In this case, the first processing unit 131 may divide and determine the number of times of arrival at the destination for each branch point based on the day of the week and the time section.

The first processing unit 131 may determine a driving probability from the corresponding branch point to the destination based on a ratio of a cumulative sum value. The first processing unit 131 may determine the driving probability based on a ratio of a cumulative sum value that has reached a specific destination from a total cumulative sum value of past driving data that has reached a plurality of destinations from the corresponding branch point.

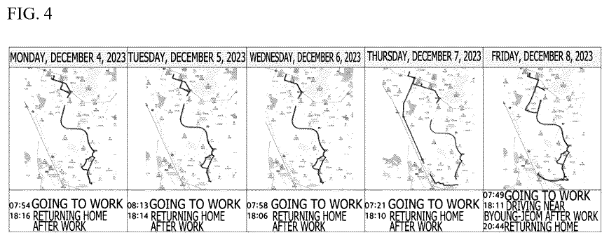

FIGS. 4 to 7 are views for describing the operation of the first processing unit.

FIG. 4 is a view graphically displaying a departure point, a destination, and a route driven between the departure point and the destination based on a day of the week and a time section in driving route data. Referring to FIG. 4 together, it may be confirmed that a record of driving between the departure point and the destination based on the day of the week and the time is recorded in the past driving route data. There may be a plurality of branch points between the departure point and the destination.

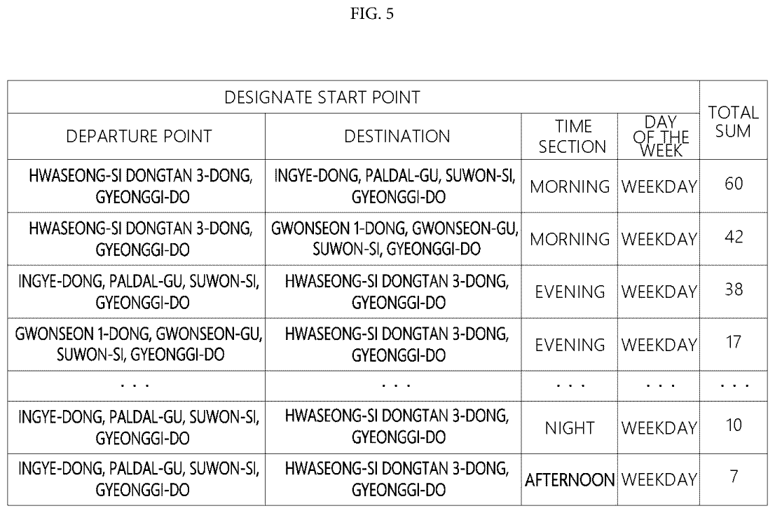

Referring to FIG. 5, the first processing unit 131 may cumulatively determine the number of times of movement between the departure point and the destination for each specific time section and day of the week from past driving route data, select a driving route with the accumulated number of movements equal to or greater than a threshold number, and use the selected driving route as a route for determining a driving probability.

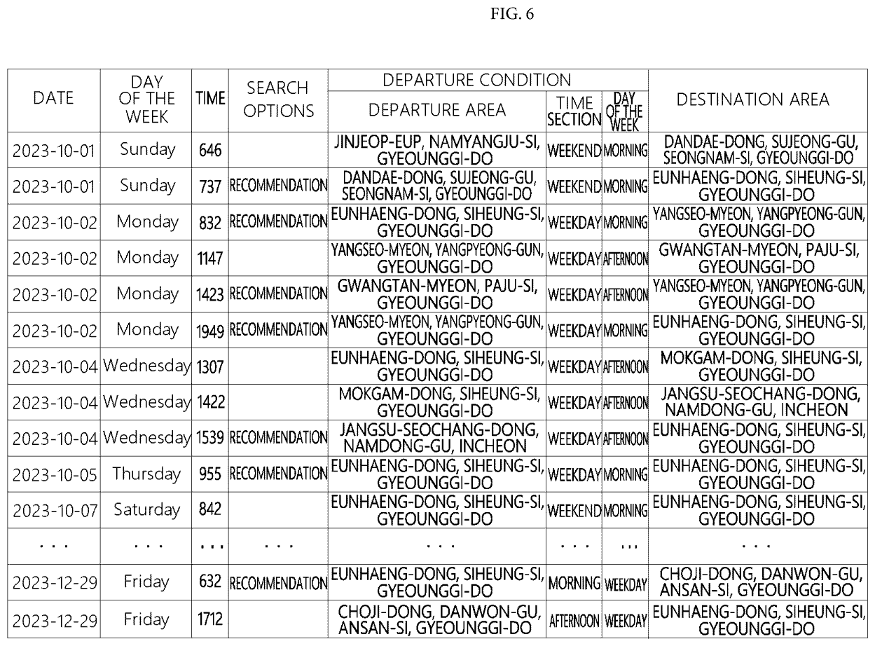

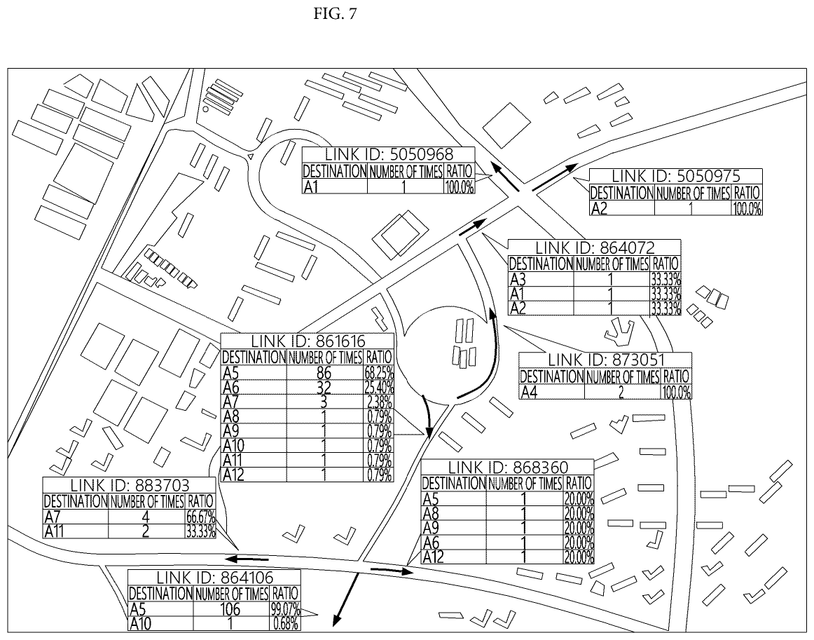

Referring to FIGS. 6 and 7, the first processing unit 131 may extract the driving route selected in FIG. 5 and sort and process the data based on the day of the week and time. The first processing unit 131 may convert Monday to Friday into weekdays, and Saturday, Sunday, and holidays into weekends, and then sort and process data based on the converted days of the week. In addition, the first processing unit 131 may classify a time section between 6 am and 12 pm as a morning time section, a time section between 12 pm and 6 pm as an afternoon time section, a time section between 6 pm and 12 am as an evening time section, and a time section between 12 am and 6 am as an early morning time section, and sort and process data based on the classified time sections.

The first processing unit 131 may extract a branch point on the driving route and determine a cumulative sum value of past driving data for arrival at a plurality of destinations from the corresponding branch point for each day of the week and time section and branch point. The first processing unit 131 may determine the driving probability as a ratio of a cumulative sum value of reaching a specific destination from a total cumulative sum value of reaching the plurality of destinations from the corresponding branch point.

Therefore, the driving probability may refer to a value representing the cumulative number of times of heading for the specific destination from the corresponding branch point on a specific day of the week and in a specific time section as a probability. The driving probability for each branch point may be displayed on the map as a link ID, a destination, the number of times, and the ratio (probability) for each branch point through the navigation unit, as shown in FIG. 7. For example, it may be confirmed that a driving probability to a destination at address of A5 from a branch point having link ID 861616 is 68.25%, and a driving probability to the same destination from a branch point having link ID 864106 is 99.07%.

The second processing unit 132 may determine a weight for each branch point based on a distance from the departure point and an amount of change in the driving probability from a previous point. The second processing unit 132 may determine the weight based on the number of branch points located on the route and the amount of change in the driving probability toward the destination when driving from the departure point to the destination.

The second processing unit 132 may determine a first weight that decreases based on the distance from the departure point. That is, the second processing unit 132 may derive an estimated destination from a location as close to the departure point as possible by assigning a higher weight to the driving probability as the distance from the departure point is closer, and recommend a driving route.

For example, the second processing unit 132 may calculate a first weight w_{L,i} based on the following Equation 1.

$${ω}_{L , i} = \frac{{K}_{1} ( n - i )}{n} \qquad [ Equation 1 ]$$

In Equation 1, n is the number of branch points located between the departure point and the destination, indicating how many branch points there are from the departure point to the destination. In addition, i indicates a passing order of each branch point when driving toward the destination from the departure point. That is, the departure point may be set to the value i=0, a branch point through which the vehicle first passes from the departure point may be set to the value i=1, and a branch point through which the vehicle last passes may be set to i=n−1.

K₁ is a changeable parameter, and may refer to a maximum value of the first weight.

The first weight decreases as the vehicle moves away from the departure point based on the location on the driving route. That is, the weight is greater at a closer distance from the departure point, and the value may have a value between the maximum K₁ and the minimum K₁/n.

For example, when the total number of branch points is 10 and the K₁ value is 10, the first weight at the departure point, that is, i=0, may be calculated as the maximum value of 10, and the first weight at the branch point through which the vehicle last passes, that is, i=9, may be calculated as 1.

The second processing unit 132 may determine a probability difference value from a previous driving probability in a driving route order and determine a second weight that increases based on the probability difference value. That is, when the driving probability to a specific destination from a specific branch point significantly increases compared to the driving probability from the previous branch point, the second processing unit 132 may determine that the driving probability to the specific destination is high, and thus determine the second weight to be high.

For example, the second processing unit 132 may calculate a second weight w_{P,j} based on the following Equation 2.

$${ω}_{P , j} = \frac{{K}_{2} j}{n} \qquad [ Equation 2 ]$$

In Equation 2, n is the number of branch points located between the departure point and the destination, indicating how many branch points there are from the departure point to the destination. In addition, j refers to an index sorted in the order in which probability difference value increases. For example, a branch point having the smallest probability difference value may be set to the value j=1, and a branch point having the largest probability difference value may be set to the value j=n.

K₂ is a changeable parameter, and may refer to a maximum value of the second weight.

As the second weight, a higher weight is given to a section where a difference in driving probability to the destination between branch points is large, and the weight increases as the j value increases.

For example, when the total number of branch points is 10 and the K₂ value is 10, the second weight may be calculated as 10 at a branch point having the highest probability difference value (j=10), and the second weight may be calculated as 1 at a branch point having the lowest probability difference value j=1).

The second processing unit 132 may compute a third weight using the first and second weights. The second processing unit 132 may determine a harmonic mean of the first and second weights as the third weight.

The second processing unit 132 may calculate the third weight based on the following Equation 3.

$$ω = har ( {ω}_{L , i} , {ω}_{P , j} ) = \frac{1}{\frac{1}{{ω}_{L , i}} + \frac{1}{{ω}_{P , j}}} \qquad [ Equation 3 ]$$

The harmonic mean is a method of calculating an average that balances the first weight and the second weight, and may calculate the third weight by harmoniously combining the two weights without being biased toward either of the two weights.

A final weight may be calculated by balancing a weight in which the distance from the departure point to the destination is considered and a weight in which a probabilistic importance of each section is considered through the third weight.

The third processing unit 133 may determine a final driving probability by reflecting a weight in the driving probability. The third processing unit 133 may determine the final driving probability by reflecting the third weight in each driving probability at each branch point. The third processing unit 133 may determine the final driving probability by multiplying a destination-specific driving probability calculated for each branch point by the third weight.

The fourth processing unit 134 may recommend a destination based on the final driving probability. When an estimated destination whose final driving probability is equal to or greater than a preset threshold probability is derived, the fourth processing unit 134 may recommend a route based on the estimated destination at the corresponding branch point.

For example, when the final driving probability from a branch point L to a destination T is equal to or greater than a threshold probability, the fourth processing unit 134 may set the destination T as the estimated destination at the branch point L.

When the vehicle is traveling in a state of not setting a destination, the fourth processing unit 134 may automatically set the route to the estimated destination T at a time point at which the vehicle passes through the branch point L and start guidance. Through this process, even when there is no separate destination setting, automatic destination setting and route guidance based on probability may be performed by analyzing regular driving data.

In addition, the fourth processing unit 134 may display a driving route based on the estimated destination through the navigation unit.

In addition, the fourth processing unit 134 may display the final driving probability based on the destination for each branch point through the navigation unit.

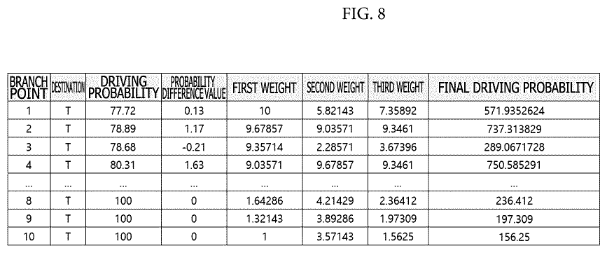

FIG. 8 is a diagram for describing the operation of the processor based on the embodiment. In FIG. 8, the total number of branch points is 10, a branch point 1 may refer to a departure point, and a branch point 10 may refer to a final branch point through which the vehicle passes on a corresponding driving route. In addition, maximum values of the first and second weights may be set to 10.

Referring to FIG. 8, the first processing unit 131 may determine a cumulative number of times of driving to a destination T for each branch point using past driving data and through the calculating, determine a driving probability to a corresponding destination.

The second processing unit 132 may determine the first weight based on a distance from the departure point. The first weight at branch point 1 (the departure point) is calculated as 10, while the first weight at the final branch point 10 is calculated as 1.

The second processing unit 132 may determine a difference value between a driving probability at a previous branch point and a driving probability at a current branch point, and determine the second weight using the difference value. It may be confirmed that the second weight has the highest value at a branch point 2, where the difference value in driving probability is the greatest.

The second processing unit 132 may determine the third weight through a harmonic mean of the first and second weights. In the value of the third weight, the values of the first and second weights are equally reflected, so that it may be confirmed that the larger each weight value is, the higher the third weight is calculated to be.

The third processing unit 133 may determine a final driving probability by multiplying the driving probability by the third weight for each branch point. The final driving probability may be expressed as a general integer value rather than a percentage value.

The fourth processing unit 134 may derive an estimated destination by comparing the final driving probability with a threshold probability. For example, when the threshold probability value is set to 600, the fourth processing unit 134 may derive an estimated destination at branch points 2 and 4 as T. The fourth processing unit 134 may automatically set the route guidance to the estimated destination T at a time point at which the vehicle passes through the branch point 2 based on a passing order of the vehicle. This method enhances driver convenience by initiating route guidance as soon as possible after departure.

The vehicle based on the embodiment may set regular driving candidates using past driving data, and automatically estimate a desired destination of the driver when the departure point, the time section, and the day of the week are provided.

When the driver provides departure conditions including the departure point, the day of the week, and the time at regular intervals (daily, weekly, monthly, or other intervals), a function of defining a route to the destination and automatically setting the destination and providing route guidance when a route search request is not made through the provided departure conditions is provided.

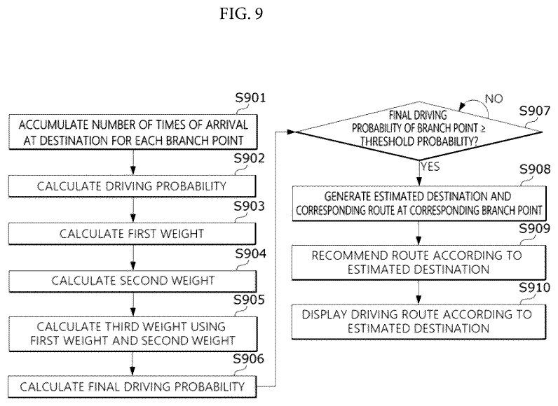

FIG. 9 is a flowchart of a method of controlling a vehicle based on an embodiment. Referring to FIG. 9, the processor accumulates the number of times of arrival at a destination for each of the branch points including a departure point using past driving route data stored in the memory (S901).

Next, the processor classifies the past driving route data of the vehicle based on day-of-the-week information and time information and determines a driving probability (S902).

Next, the processor calculates a first weight that decreases based on a distance from the departure point (S903).

Subsequently or simultaneously, the processor determines a probability difference value from a previous driving probability in a driving route order, and calculates a second weight that increases based on the probability difference value (S904).

Next, the processor calculates a third weight by combining the first weight and the second weight (S905).

Next, the processor determines a final driving probability by reflecting the third weight in the driving probability for each branch point (S906).

Next, the processor compares the final driving probability to a preset threshold probability (S907).

Next, the processor generates an estimated destination and a corresponding route at a corresponding branch point when the final driving probability is equal to or greater than the preset threshold probability (S908).

Next, the processor recommends a route based on the estimated destination when the vehicle passes through the corresponding branch point. In this case, the processor displays a driving route based on the estimated destination through the navigation unit (S909 and S910).

The term “˜unit” used in the present embodiment refers to software component or hardware components such as a field-programmable gate array (FPGA) or an application specific integrated circuit (ASIC), and “˜unit” performs certain functions. However, the “˜unit” is not restricted to software or hardware. The “˜unit” may be configured to reside in an addressable storage medium, or may be configured to reproduce one or more processors. Therefore, for example, “˜unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “˜unit” may be combined into smaller numbers of components and “˜units,” or may be further divided into additional components and “˜units.” Furthermore, the components and “˜units” may be implemented to reproduce one or more CPUs in a device or a security multimedia card.

A vehicle based on an embodiment and a method of controlling the vehicle can automatically suggest a suitable destination and a driving route based on a driving record of the vehicle.

In addition, the vehicle and the method of controlling the vehicle can automatically suggest a destination and a driving route with a high probability based on past regular driving records of the vehicle.

In addition, the vehicle and the method of controlling the vehicle can automatically suggest a destination and a driving route at a time point at which a driving probability of the vehicle is the highest.

In this way, it is possible to offer highly reliable suggestions and reduce fatigue caused by frequent suggestions.

Although the preferred embodiments of the present invention have been described above, those skilled in the art may implement various modifications and adjustments without departing from the spirit and scope of the invention as defined in the claims below.

What is claimed is:

1. A vehicle comprising:
one or more processors; and
a memory storing one or more programs executed by the one or more processors,
wherein the processor includes:
a first processing unit configured to determine a respective driving probability for a destination for each of branch points including a departure point, using past driving route data stored in the memory;
a second processing unit configured to determine a weight for each branch point based on a distance from the departure point and an amount of change in the driving probability from a previous branch point;
a third processing unit configured to determine a final driving probability by applying the weight to the driving probability; and
a fourth processing unit configured to recommend a destination based on the final driving probability.

2. The vehicle of claim 1, wherein the first processing unit accumulates number of times of arrival at the destination from the branch point based on the past driving route data of the vehicle and determines the driving probability based on a ratio of a cumulative sum value.

3. The vehicle of claim 2, wherein the first processing unit classifies the past driving route data of the vehicle based on day-of-the-week information and time information and refines the driving probability.

4. The vehicle of claim 1, wherein the second processing unit determines a first weight that decreases based on the distance from the departure point.

5. The vehicle of claim 4, wherein the second processing unit determines a probability difference value from a previous driving probability in a driving route order and determines a second weight that increases based on the probability difference value.

6. The vehicle of claim 5, wherein the second processing unit determines a third weight using the first weight and the second weight.

7. The vehicle of claim 6, wherein the third processing unit determines the final driving probability by applying the third weight to adjust the driving probability at each branch point.

8. The vehicle of claim 1, wherein when an estimated destination with the final driving probability is equal to or greater than a preset threshold probability is identified, the fourth processing unit recommends a route based on the estimated destination at a corresponding branch point.

9. The vehicle of claim 8, wherein the fourth processing unit displays a driving route on a navigation unit based on the estimated destination.

10. The vehicle of claim 9, wherein the fourth processing unit recommends a route based on the estimated destination when the vehicle passes the corresponding branch point.

11. A method performed by a computing apparatus including one or more processors and a memory storing one or more programs executed by the one or more processors, comprising:
determining, by the processor, a driving probability for a destination for each of branch points including a departure point based on past driving route data stored in the memory;
determining, by the processor, a weight for each branch point based on a distance from the departure point and an amount of change in the driving probability from a previous point;
determining, by the processor, a final driving probability by applying the weight to adjust the driving probability; and
recommending, by the processor, a destination based on the final driving probability.

12. The method of claim 11, wherein the determining of the driving probability includes accumulating number of times of arrival at the destination from the branch point based on the past driving route data of the vehicle and determining the driving probability based on a ratio of a cumulative sum value.

13. The method of claim 12, wherein the determining of the driving probability includes classifying the past driving route data of the vehicle based on day-of-the-week information and time information and refining the driving probability.

14. The method of claim 11, wherein the determining of the weight includes determining a first weight that decreases based on the distance from the departure point.

15. The method of claim 14, wherein the determining of the weight further includes:
determining a probability difference value from a previous driving probability in a driving route order; and
determining a second weight that increases based on the probability difference value.

16. The method of claim 15, wherein the determining of the weight further includes determining a third weight using the first weight and the second weight.

17. The method of claim 16, wherein the determining of the final driving probability includes applying the third weight to modify the driving probability at each branch point.

18. The method of claim 11, wherein the recommending of the destination includes recommending a route based on an estimated destination at a corresponding branch point when the estimated destination with the final driving probability is equal to or greater than a preset threshold probability is identified.

19. The method of claim 18, wherein the recommending of the destination further includes displaying a driving route on a navigation unit based on the estimated destination

20. The method of claim 19, wherein the recommending of the destination includes recommending a route based on the estimated destination when the vehicle passes the corresponding branch point.
